(19) United States
(12) Patent Application Publication
(10) Pub. No.: US 2007/0192962 A1
(43) Pub. Date: Aug. 23, 2007

(54) Aqueous Compositions Containing Alkoxylated Alcohols And Hydrophobic Components, Method For The Production And Use Thereof

(75) Inventors: Rainer Erhardt, Mannheim (DE); Gunther Pabst, Neumarkt (DE); Gunter Oetter, Frankenthal (DE); Andreas Seitz, Birkenheide (DE); Peter Danisch, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/547,855

(22) PCT Filed: May 13, 2005
(86) PCT No.: PCT/EP05/05225

§ 371 Date: Oct. 6, 2006

(30) Foreign Application Priority Data
May 17, 2004 (DE) 102004024798.6

(51) Int. Cl. C14C 1/06

(52) U.S. Cl. 8/94.16

(57) ABSTRACT

Aqueous compositions containing alkoxylated alcohols and hydrophobic components, method for the production and use thereof Compositions comprising, as components, a) at least two alkoxylated alcohols, b) at least one hydrophobic component selected from natural, modified natural and synthetic hydrophobic substances, c) at least 20% by weight, based on the total weight of the composition, of water, wherein the compositions have a mean hydrodynamic radius in the range from 1 to 200 nm, determined by dynamic light scattering.

The present invention relates to compositions comprising, as components,
(a) at least two alkoxylated alcohols,
(b) at least one hydrophobic component selected from natural, modified natural and synthetic hydrophobic substances,
(c) at least 20% by weight, based on the total weight of the composition, of water,
   wherein the composition has a mean hydrodynamic radius in the range from 1 to 200 nm, determined by dynamic light scattering.

The present invention furthermore relates to processes for the preparation of the compositions according to the invention and uses of the compositions according to the invention.

Emulsifiable fatliquoring agents play an important role in the production of leather and fur skins. Fatliquoring agents serve for softening the leather or the fur skin, for increasing its fullness and for increasing the protective effect against moisture, dirt and undesired chemical influences. An overview of traditional fatliquoring agents is to be found in Herfeld, “Bibliothek des Leders”, Vol. 4, page 13 (1987). Commercial fatliquoring agents usually consist of chemically modified natural fats, fatty oils, waxes, resins and derivatives, mineral oil fractions or secondary products thereof, cf. Herfeld, “Bibliothek des Leders”, Vol. 4, page 59 (1987).

A substantial problem in the case of many fatliquoring agents is the shelf-life. Most fatliquoring agents are sold in the form of emulsions, which separate after a certain storage time. In order to increase the shelf-life and to retard the separation of the emulsions, emulsifiers are added to the emulsions. However, it is observed that in many cases the exhaustion decreases as a result of adding relatively large amounts of emulsifier.

A further substantial problem is the fact that the exhaustion is capable of further improvement in many cases. Leathers or fur skins are usually treated with fatliquoring agents in aqueous liquors. After the fatliquoring, the aqueous liquors are usually disposed of, and unconsumed fatliquoring agent has to be degraded in wastewater treatment plants and causes an increased chemical oxygen demand (COD) of the liquors.

It has furthermore been found that numerous fatliquoring agents having a long shelf-life initially provide very good fatliquoring but lead to undesired fatty spews after some time. These fatty spews give the leather a disadvantageous soiled appearance.

It is furthermore desired that fatliquoring agents have a low proportion of volatile organic compounds (low VOC) and, when used for the production of, for example, automotive leather, cause only a slight fogging problem. DIN 75201 and DIN 75201 B define fogging as condensation of evaporated volatile components from the vehicle interior trim on the glass panes, in particular on the wind shield.

WO 03/23069 discloses that certain combinations of alkoxylated alkanols or fatty alcohols are very good emulsifiers for the fatliquoring of leather. However, WO 03/23069 does not disclose any fatliquoring agents having a long shelf-life.

It was therefore the object to provide compositions which do not have the abovementioned disadvantages

Accordingly, compositions defined at the outset were found.

(a), (b), (c), (d) and (e) are also referred to below as component (a), component (b), etc.

Compositions according to the invention comprise, as component (a), at least two, preferably a mixture of at least two, preferably at least 3, alkoxylated alcohols. Compositions according to the invention preferably comprise, as component (a), mixtures of at least two, in particular at least three, alkoxylated alcohols (a1), (a2) and (a3). Compositions according to the invention particularly preferably comprise at least one alkoxylated alcohol (a1), at least one alkoxylated alcohol (a2) and at least one alkoxylated alcohol (a3).

Alkoxylated alcohols (a1) are selected from C₆-C₁₄-alkanols, preferably from C₈-C₁₂-alkanols, particularly preferably C₁₀-alkanols, in each case alkoxylated with on average (number average) from 4 to 12 equivalents of alkylene oxide, preferably on average from 5 to 10 equivalents of alkylene oxide.

Alkoxylated alcohols (a2) are selected from one or more C₁₂-C₂₄-alkanols, preferably one or more C₁₄-C₂₀-alkanols, particularly preferably one or more C₁₆-C₁₈-alkanols, which is or are alkoxylated with on average (number average) from 15 to 40 equivalents of alkylene oxide, preferably from 20 to 30 equivalents of alkylene oxide.

Alkoxylated alcohols (a3) are selected from one or more C₁₂-C₂₄-alkanols, preferably one or more C₁₄-C₂₀-alkanols, particularly preferably one or more C₁₆-C₁₈-alkanols, which is or are alkoxylated with on average (number average) from 50 to 100 equivalents of alkylene oxide.

The C₆-C₁₄-alkanols or C₁₂-C₂₄-alkanols on which the alkoxylated alcohols (a3) are based are preferably in each case n-alkanols or mixtures of n-alkanols and isoalkanols; the C₁₂-C₂₄-alkanols on which the alkoxylated alcohols (a3) are based are particularly preferably in each case n-alkanols.

In the context of the present invention, alkylene oxides are understood as meaning identical or different C₂-C₄-alkylene oxides, such as, for example, butylene oxide, propylene oxide and in particular ethylene oxide. If it is desired to use different alkylene oxides for the preparation of, for example, (a2), the alkylene oxide units in (a2) can be arranged, for example, blockwise, alternately and preferably randomly.

On the basis of the synthesis, the abovementioned alkoxylated alcohols are usually obtained in the form of mixtures, the components of the mixtures obtained usually differing in their degree of alkoxylation. In the context of the present invention, the degree of alkoxylation therefore denotes the average degree of alkoxylation (number average), which can be determined by methods known to a person skilled in the art, such as, for example, gel permeation chromatography (GPC). In the context of the present invention, a mixture obtained by a conventional synthesis is not defined as two different alkoxylated alcohols.

Abovementioned alkoxylated alcohols (a1), (a2) and (a3) are known as such and can be prepared by reacting the relevant alcohol or alcohols with the desired amounts of alkylene oxide. The reaction can be catalyzed by adding a small amount of water and/or alkali metal hydroxide.

Component (a) can be prepared by stirring together at least two different alcohols out of at least two, in particular at least three, alkoxylated alcohols (a1), (a2) and (a3). Compositions according to the invention particularly preferably comprise at least one alkoxylated alcohol (a1), at least one alkoxylated alcohol (a2) and at least one alkoxylated alcohol (a3).

The relative proportions of (a1), (a2) and (3) can be chosen within any desired limits.

In a preferred embodiment, (a) is chosen as follows:

from 20 to 60% by weight, preferably from 25 to 50 and particularly preferably from 28 to 40% by weight, of (a1),

from 20 to 70% by weight, preferably from 25 to 60% by weight and particularly preferably from 30 to 45% by weight of (a2) and

from 10 to 50% by weight, preferably from 15 to 40% by weight and particularly preferably from 22 to 32% by weight of (a3).

Compositions according to the invention furthermore comprise at least one hydrophobic component (b) which is selected from natural, modified natural and synthetic hydrophobic substances.

Suitable natural hydrophobic substances are, for example, natural waxes, such as, for example, beeswax, cork wax, montan waxes or Carnauba wax, natural triglycerides and natural oils and natural fats, such as, for example, stearin, tung oil, fish oil, chaulmoogra oil, lanolin, shellac wax and mixtures thereof, and in particular bone oil, nit oil, hoof oil, such as, for example, neatsfoot oil, lard oil, triolein, rapeseed oil, nut oil, olive oil and castor oil.

Suitable modified natural hydrophobic substances are, for example, selected from fatty acids or fatty acid mixtures esterified with, for example, methanol or ethanol, in particular rapeseed oil methyl ester; oxidized and sulfited natural oils and oxidized and sulfated natural oils, oxidized and sulfited oils being preferred. Oxidized and sulfited rapeseed oil and oxidized and sulfited fish oil and mixtures of the above-mentioned modified hydrophobic substances are particularly preferred.

Highly oxidized low-sulfited natural oils or fats, in particular highly oxidized low-sulfited rapeseed oil or fish oil, are preferred.

In the context of the present invention, highly oxidized is to be understood as meaning that Δd, the difference between the densities of oil and fat after and before the oxidation, is in the range from 0.01 to 0.1, preferably from 0.03 to 0.05. In the context of the present invention, low-sulfited is to be understood as meaning that oxidized neutral oil and oxidized neutral fat is reacted with from 2 to 8% by weight, preferably from 3 to 5% by weight, of one or more sulfites, calculated as Na₂S₂O₅.

Suitable synthetic hydrophobic substances are, for example, selected from mineral oils, white oils, silicone oils, synthetic waxes and hydrophobic (co)polymers.

Polydimethylsilicones having a dynamic viscosity in the range from 10 to 700 mPa·s, preferably in the range from 30 to 500 mPa·s, determined in each case according to DIN EN ISO 3219 at 23° C., may be mentioned as examples of silicone oils. Further suitable silicone oils are, for example, polydimethylsilicones in which from 1 to 50 mol % of the methyl groups have been replaced by phenyl groups or C₂-C₁₀-alkyl groups and which have a dynamic viscosity in the range from 10 to 700 mPa·s, preferably in the range from 30 to 500 mPa·s, determined in each case according to DIN EN ISO 3219 at 23° C.

Polyethylene waxes or ethylene copolymer waxes as are obtainable, for example, by free radical polymerization of ethylene or free radical copolymerization of ethylene with, for example, (meth)acrylic acid or by Ziegler-Natta catalysis, may be mentioned as examples of synthetic waxes. Polyisobutylene waxes may furthermore be mentioned. Paraffin mixtures may furthermore be mentioned; these are to be understood as meaning mixtures of hydrocarbons which have 12 or more carbon atoms and usually have a melting point in the range from 25 to 45° C. Paraffin mixtures of this type may be obtained, for example, in refineries or crackers and are known to a person skilled in the art as slack wax and sasol waxes. Montan ester waxes are a further example of synthetic waxes.

In the context of the present invention, hydrophobic (co)polymers may also be self-emulsified and are selected, for example, from
unhydrolyzed, partly hydrolyzed or quantitatively hydrolyzed copolymers of ethylenically unsaturated C₄-C₁₀-dicarboxylic anhydrides, such as, for example, maleic anhydride or itaconic anhydride, and C₁₀-C₄₀-α-olefins,
polyisobutenes having a molecular weight Mₙ in the range from 500 to 500 000 g/mol, preferably from 1000 to 100 000 g/mol,
unhydrolyzed, partly hydrolyzed or quantitatively hydrolyzed copolymers of ethylenically unsaturated C₄-C₁₀-dicarboxylic anhydrides, such as, for example, maleic anhydride or itaconic anhydride, and vinylaromatics, such as, for example, styrene or para-methylstyrene,
random copolymers of vinylaromatics, such as, for example, styrene, and ethylenically unsaturated C₃-C₁₀-carboxylic acids, such as, for example, (meth)acrylic acid,
copolymers of butadiene and styrene,
block copolymers of vinylaromatics, such as, for example, styrene, and ethylenically unsaturated C₃-C₁₀-carboxylic acids, such as, for example, (meth)acrylic acid,
copolymers, in particular block copolymers, of isobutene and alkylene oxide, in particular ethylene oxide,

Hydrophobic substances and in particular synthetic hydrophobic substances which are suitable as component (b) can certainly have self-emulsifying properties. Thus, for example, copolymers of α-C₂₀-C₂₄-olefins and maleic anhydride in any molar ratio, in particular in the molar ratio of 1:1, are suitable as hydrophobic copolymers, and furthermore oxidized polyethylene waxes, for example those having an acid number in the range from 1 to 150 mg KOH/g of wax, determined according to DIN 53402.

Compositions according to the invention furthermore comprise water (c), in particular at least 20% by weight, based on the total weight of composition according to the invention, preferably at least 40% by weight.

The compositions according to the invention have a mean hydrodynamic radius in the range from 1 to 200 nm, preferably from 10 to 120 nm and particularly preferably from 20 to 75 nm, determined by dynamic light scattering. For the determination of the mean hydrodynamic radius, the self-diffusion coefficient can be determined by methods known per se to a person skilled in the art, and the mean hydrodynamic radius can be calculated according to the Stokes-Einstein equation.

In an embodiment of the present invention, compositions according to the invention may have, at 20° C., a dynamic viscosity η in the range from 0.5 to 20 mPa·s, determined, for example, with the aid of a dynamic cylinder measuring method.

In an embodiment of the present invention, compositions according to the invention have, in aqueous dilution of 1:499 (parts by volume) a transmittance of at least 80%, preferably from 80 to 95% and particularly preferably from 85 to 90%, measured at a wavelength of 400 nm and a sample layer thickness of 1 cm. The transmittance can easily be determined, for example, in commercial UV/VIS spectrometers.

Compositions according to the invention prove to be very stable. Their tendency to break is extremely low. Even in the presence of salt-containing aqueous solutions and in particular with respect to water containing calcium ions, i.e. hard water having a hardness of 21° dH or more, they remain stable. Even in the presence of aqueous solutions of sodium carbonate, formic acid, glauber salt or chromium salts, they remain stable.

In an embodiment of the present invention, compositions according to the invention may comprise

(d) at least one ionic or nonionic emulsifier.

Suitable ionic emulsifiers are selected from cationic, anionic and zwitterionic emulsifiers.

In principle, all compounds which are surface-active in aqueous systems and may also be of a nonionic, anionic, cationic or zwitterionic nature can be used as emulsifiers (d).

Particularly suitable emulsifiers (d) are N-acylated amino acid derivatives, for example of the formula I 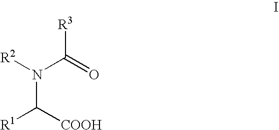
in which the variables are defined as follows:
R¹ is hydrogen,
   C₁-C₄-alkyl, such as methyl, ethyl, n-propyl, isopropyl, n-butyl, isobutyl, sec-butyl and tert-butyl, in particular methyl;
   C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
R² C₁-C₄-alkyl, such as methyl, ethyl, n-propyl, isopropyl, n-butyl, isobutyl, sec-butyl and tert-butyl; in particular methyl.

The CO—R³ group is usually derived from saturated or unsaturated fatty acids.

Saturated fatty acids are to be understood as meaning carboxylic acids having C₉-C₂₀-alkyl groups, which may be linear or branched, substituted or unsubstituted. R³ may be, for example, n-nonyl, n-decyl, n-dodecyl, n-tetradecyl, n-pentadecyl, n-octadecyl or n-eicosyl.

CO—R³ may be derived from an unsaturated fatty acid having 9 to 20 carbon atoms and one to 5 C—C double bonds, it being possible for the C—C double bonds to be, for example, isolated or allylic, for example the acyl radical of linoleic acid, of linolenic acid and very particularly preferably of oleic acid.

In an embodiment of the present invention, all, or at least a certain proportion, for example a third or a half, of the carboxyl groups in N-acylated amino acid derivatives used as emulsifiers are neutralized. For example, basic salts, such as hydroxides or carbonates of the alkali metals, such as, for example, Na or K, are suitable for the neutralization. Ammonia, alkylamines, such as, for example, methylamine, dimethylamine, trimethylamine, ethylamine, diethylamine, triethylamine or ethylenediamine, and very particularly alkanolamines, such as, for example, ethanolamine, diethanolamine, triethanolamine, N-methylethanolamine, N-methyldiethanolamine or N-(n-butyl)diethanolamine, are furthermore suitable for the neutralization. Depending on the degree of neutralization and pH, emulsifiers of the general formula I are therefore cationic, anionic or zwitterionic emulsifiers.

N-Oleylsarcosine, N-stearyisarcosine, N-lauroylsarcosine and N-isononanoylsarcosine and the respective ethanolammonium salts, diethanolammonium salts and N-methyldiethanolammonium salts may be mentioned by way of example as typical compounds of the formula I.

In another embodiment of the present invention, emulsifiers (d) are sulfited succinic monoesters or sulfited succinic esters of the general formula II 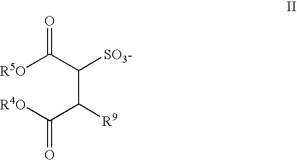
where
R⁴ and R⁵ are identical or preferably different and are selected from hydrogen,
C₁-C₃₀-alkyl, branched or straight-chain, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetradecyl, n-hexadecyl, n-octadecyl or n-eicosyl, preferably radicals of the formula II a 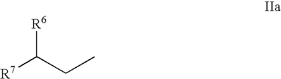
which are branched in the β-position, (CH₂CH₂O)ₓ—O—R⁸ or [CH(CH₃)CH₂O)ₓ—O—R⁸, where x is an integer in the range from 1 to 20,
C₆-C₁₄-aryl, for example phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl;
R⁹ is selected from C₁-C₄-alkyl, such as methyl, ethyl, n-propyl, isopropyl, n-butyl, isobutyl, sec-butyl and tert-butyl
   and in particular hydrogen;
R⁶ and R⁷ are identical or preferably different and are selected from C₁-C₂₇-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, n-nonyl, n-decyl, n-undecyl, n-dodecyl, n-tridecyl, n-tetradecyl, n-hexadecyl, n-octadecyl and n-eicosyl;
   the sum of the carbon atoms of R⁶ and R⁷ being not more than 30. R⁶ preferably has two carbon atoms more than R⁷; for example, the following combinations are preferred:
R⁶ n-undecyl and R⁷=n-nonyl,
   R⁶=n-dodecyl and R⁷=n-decyl,
   R⁶=n-tridecyl and R⁷=n-undecyl,
   R⁶=n-tetradecyl and R⁷=n-dodecyl,
   R⁶=n-pentadecyl and R⁷=n-tridecyl.
R⁸ is selected from C₁-C₄-alkyl, such as methyl, ethyl, n-propyl, isopropyl, n-butyl, isobutyl, sec-butyl, tert-butyl,
   phenyl, ortho-tolyl, meta-tolyl, para-tolyl
   and in particular hydrogen.

In a preferred embodiment of the present invention, exactly one of the radicals R⁴ and R⁵ is hydrogen and the other radical is selected from C₁-C₃₀-alkyl.

In a particularly preferred embodiment of the present invention, a mixture of a plurality of compounds, for example of the formula II, are chosen, which compounds may differ, for example, in that, in the first compound of the formula II, R⁴ is hydrogen and R⁵ is selected from C₁-C₃₀-alkyl and, in the second one, R⁵ is hydrogen and R⁴ is selected from C₁-C₃₀-alkyl.

In an embodiment of the present invention, all, or at least a certain proportion, for example a third or a half, of the sulfonyl groups in compounds of the general formula II which are used as emulsifier (d) are neutralized. For example, basic salts, such as hydroxides or carbonates of the alkali metals, such as, for example, Na or K, are suitable for the neutralization. Ammonia, alkylamines, such as, for example, methylamine, dimethylamine, trimethylamine, ethylamine, diethylamine, triethylamine and ethylenediamine, and very particularly preferably alkanolamines, such as, for example, ethanolamine, diethanolamine, triethanolamine, N-methylethanolamine, N-methyldiethanolamine or N-(n-butyl)diethanolamine, are furthermore suitable for the neutralization.

The preparation of compounds of the formula II is known per se and is described in WO 01/68584. It is effected, for example, by mono- or diesterification of dicarboxylic anhydrides of the general formula III 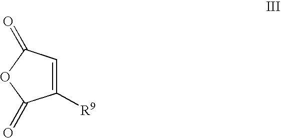
with corresponding alcohols, which need not be present in pure form, followed by a reaction with disulfite.

Instead of pure sulfur-containing compounds, for example sulfur-containing compounds of the formula V, mixtures of different sulfur-containing compounds may be used. For example, it is possible to use the mixture known as oxo oil 135 or oxo thick oil 135 (WO 01/68584) for the esterification.

In an embodiment of the present invention, formulations used in the process according to the invention may contain up to 40% by weight, preferably up to 20% by weight, based on the formulation, of at least one alcohol of the formula IV 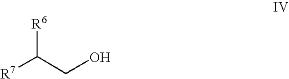
where, in the formulae III and IV, the variables are defined as above.

In an embodiment of the present invention, compositions according to the invention may comprise

(e) at least one additive.

The following additives may be mentioned by way of example: tanning agents, in particular polymeric tanning agents, as described, for example, in EP-B 0 891 430, vegetable tanning agents and synthetic tanning agents, for example described in EP-A 0 459 168, and furthermore dispersants, for example described in EP-A2 0 463 401.

In an embodiment of the present invention, compositions according to the invention are substantially free of low molecular weight alcohols and low molecular weight glycols. In the context of the present invention, alcohols having up to 8 carbon atoms, in particular alkanols having up to 8 carbon atoms and in particular ethanol, isopropanol and n-pentanol, may be mentioned as low molecular weight alcohols. In the context of the present invention, low molecular weight glycols are to be understood as meaning compounds having up to 6 carbon atoms and at least two alcoholic hydroxyl groups. Ethylene glycol, propylene glycol, isopropylene glycol, 1,4-butanediol, 1,2-butanediol, 2,3-butanediols, isobutene glycol, 1,3-butanediol, 1,2-hexanediol and 1,6-hexanediol may be mentioned by way of example, as well as glycerol, trimethylolpropane and isomeric 2,3,4-propanetriols. In the context of the present invention, substantially free means, for example, that compositions according to the invention comprise less than 0.1% by weight, preferably less than 0.01% by weight, of low molecular weight alcohols or glycol and in particular in the range of from 10 ppm to 0.05% by weight of low molecular weight alcohols and glycol together, data in % by weight being based in each case on the total weight of composition according to the invention.

In an embodiment of the present invention, compositions according to the invention have a pH in the range from 3 to 7, preferably in the range from 4 to 6.

In an embodiment of the present invention, compositions according to the invention comprise

from 0.1 to 50% by weight, preferably from 2.5 to 10% by weight, of component (a),

from 5 to 50% by weight, preferably from 10 to 40% by weight, of component (b),

from 20 to 90% by weight, preferably from 40 to 80% by weight, of water (c),

from 0 to 40% by weight, preferably from 1 to 20% by weight, of ionic or nonionic emulsifier (d),

from 0 to 50% by weight, preferably from 15 to 30% by weight, of additives (e),

data in % by weight being based in each case on the total weight of the relevant composition according to the invention.

The present invention furthermore relates to a process for the preparation of compositions according to the invention, also referred to below as preparation process according to the invention.

In an embodiment of the preparation process according to the invention,
(a) at least one mixture of at least two different alkoxylated alcohols,
(b) at least one hydrophobic component selected from natural, modified natural and synthetic hydrophobic substances,
(d) if appropriate, at least one ionic or nonionic emulsifier and
(e) if appropriate, at least one additive are mixed with one another and then
(c) at least 20% by weight, preferably at least 40% by weight, based on the total weight of the composition, of water are added,
   the water (c) having a temperature of at least 70° C., preferably in the range from 80° to 100° C., during the addition.

Preferably, water (c) is added slowly. In relation to the present invention, slowly means that no more than 1 liter of water (c), which has a temperature of at least 70° C. during the addition, is added over a period of 5 minutes. Addition of water (c) which has a temperature of at least 70° C. during the addition in one portion and in the course of 3 minutes per liter or less is usually avoided.

After the addition of water (c) which has a temperature of at least 70° C., preferably in the range from 80° C. to 100° C., during the addition, the mixture can be allowed to cool to room temperature, for example with thorough mixing. Stirring can be continued even after addition of water (c), which has a temperature of at least 70° C., preferably in the range from 80° C. to 100° C., over a period of from 5 minutes to 10 hours at a temperature above room temperature, for example at 70° C. or in particular in the range from 80 to 100° C., and cooling to room temperature effected only thereafter.

In another embodiment of the preparation process according to the invention, for example,
(a) at least one mixture of at least two different alkoxylated alcohols,
(b) at least one hydrophobic component selected from natural, modified natural and synthetic hydrophobic substances,
(c) at least 20% by weight, preferably at least 40% by weight, based on the total weight of composition according to the invention, of water,
(b) if appropriate, at least one ionic or nonionic emulsifier and
(e) if appropriate, at least one additive
   are mixed with one another, for example at room temperature or at a temperature in the range from 20 to 50° C., and then the mixture thus obtained is heated to a temperature of at least 70° C., preferably to a temperature in the range from at least 80° C. to 100° C.

In this embodiment of the preparation process according to the invention, it is possible to use water (c) which has any desired temperature, for example in the range from 0 to 100° C., for the mixing. For practical reasons, water (c) which has a temperature in the range from 10 to 30° C. can be used for the mixing.

After the heating to a temperature of at least 70° C., preferably to a temperature in the range from at least 80° C. to 100° C., the mixture can be kept at a temperature of at least 70° C. over a period of from several minutes to 24 hours, preferably from at least one hour to 8 hours, if appropriate with further stirring, and only thereafter cooled again to room temperature.

In another embodiment of the preparation process according to the invention, for example,
(a) at least one mixture of at least two different alkoxylated alcohols,
(b) at least one hydrophobic component selected from natural, modified natural and synthetic hydrophobic substances,
(c) at least 20% by weight, preferably at least 40% by weight, based on the total weight of composition according to the invention, of water, which comprises
(d) if appropriate, at least one ionic or nonionic emulsifier and
(e) if appropriate, at least one additive,
   are mixed with one another, for example at room temperature or at a temperature in the range from 20 to 50° C., and then the mixture thus obtainable is heated to a temperature of at least 70° C., preferably to a temperature in the range from at least 80° C. to 100° C.

In this embodiment of the preparation process according to the invention, water (c) containing, if appropriate, at least one ionic or nonionic emulsifier (d) and, if appropriate, at least one additive and which has any desired temperature, for example in the range from 0 to 100° C., can be used. For practical reasons, water (c) which has a temperature in the range from 10 to 30° C. can be used for the mixing.

After the heating to a temperature of at least 70° C., preferably to a temperature in the range from at least 80° C. to 100° C., the mixture can be kept at a temperature of at least 70° C. over a period of from several minutes to 24 hours, preferably from at least one hour to 8 hours, if appropriate with further stirring, and can be cooled again to room temperature only thereafter.

The present invention furthermore relates to the use of compositions according to the invention or of compositions which are prepared by the preparation process according to the invention for the production of leather or fur skins. The present invention furthermore relates to a process for the production of leather or fur skins using compositions according to the invention or compositions prepared by the preparation process according to the invention, also referred to below as fatliquoring process according to the invention.

For carrying out the fatliquoring process according to the invention, leathers or fur skins are treated in a usually aqueous liquor before, during or after the retanning with at least one composition used according to the invention. The fatliquoring process according to the invention can be carried out once or repeatedly. The leathers to be fatliquored may have been produced by any desired methods, for example by mineral tanning, in particular chrome tanning, or by polymer tanning, tanning with syntans, resin tanning, tanning with vegetable tanning agents or tanning with combinations of the abovementioned tanning agents.

In an embodiment of the fatliquoring process according to the invention, at least one composition according to the invention is added in one or more portions to the leather to be fatliquored or to the furs to be fatliquored. Preferably, the liquor length can be from 50 to 2000% by weight, preferably from 100 to 400% by weight, based on the shaved weight of the leather or the wet weight of the fur skins.

The fatliquoring process according to the invention is carried out in general by a procedure in which the leather to be fatliquored or the fur skins to be fatliquored are drummed in suitable vessels, for example in drums, in particular in rotatable drums having internals. Other methods known to a person skilled in the art are also possible for mixing.

Temperatures in the range from 20 to 65° C., preferably from 30 to 600, may be chosen as the temperature for the process according to the invention.

The pressure conditions of the process according to the invention are in general not critical. Atmospheric pressure (1 atm) is preferably employed but it is also possible to employ reduced pressure, such as, for example, from 0.5 to 0.99 atm, or superatmospheric pressure, such as, for example, from 1.01 to 2 atm.

A pH in the range from 4 to 8, preferably from 4.5 to 8, can be established as a pH at the beginning of the fatliquoring process according to the invention. At the end of the fatliquoring process according to the invention, the pH can be reduced to a pH of from 3 to 5 by adding an acid, for example formic acid.

The fatliquoring process according to the invention is generally terminated after a time of from 20 minutes to 24 hours, preferably from 30 minutes to 12 hours. If the fatliquoring process according to the invention is carried out repeatedly, the term “fatliquoring steps according to the invention” is used in the context of the present invention.

For example, from 0.1 to 20% by weight, in particular from 0.5 to 15% by weight, of composition according to the invention can be used per fatliquoring step according to the invention or in the fatliquoring process according to the invention, based on the shaved weight of the leathers to be treated or the wet weight of the furs to be treated.

During the fatliquoring process according to the invention, conventional leather dyes may be added to the liquor. Acidic, substantive or basic aniline dyes, which can be used in amounts customary in tanning, may be mentioned by way of example.

If it is desired to carry out the fatliquoring process according to the invention in combination with the retanning, it is possible to employ any desired tanning agents customary in tanning, for example mineral tanning agents, in particular chrome tanning agents, or polymer tanning agents, syntans, resin tanning agents, vegetable tanning agents or combinations of the abovementioned tanning agents, which may be added separately or together with the composition according to the invention.

It is observed that the exhaustion of the compositions according to the invention is excellent; residual liquors (wastewater), which remain after the fatliquoring process according to the invention has been carried out and are usually disposed of, have a reduced chemical oxygen demand.

After the fatliquoring process according to the invention, the leathers or fur skins fatliquored according to the invention can be worked up in a manner customary in tanning.

Leathers and fur skins obtained by the fatliquoring process according to the invention, also referred to below as leathers and fur skins fatliquored according to the invention, are distinguished by particularly good hand properties, very low fogging values and pleasant mechanical properties.

The present invention furthermore relates to the use of the leathers fatliquored according to the invention for the production of articles of clothing, for example jackets, coats, shoes and in particular boots. The present invention furthermore relates to the use of leathers fatliquored according to the invention for the production of furniture and furniture parts, for example leather sofas, leather seats, arm rests for chairs, seats or sofas or benches. The present invention furthermore relates to the use of leathers fatliquored according to the invention for the production of automotive parts, for example automobile seats, parts of dashboards and interior trim parts, for example in automobile doors.

The invention is illustrated by working examples.

General Remarks:

The determinations of the mean hydrodynamic radius were effected using a laser goniometer from ALV-Laser GmbH, Langen (model ALV/SP-86). An He—Ne laser (model LHRP-3501 from Laser2000), having a wavelength of 633 nm and a power of 35 mW, acted as a light source. An ALV/High Quantum Efficiency Avalanche Photodiode/High Performance AQ Detector with up-circuit ALV/Static and Dynamic Enhancer was used for the detection. A thermostat (MWG Lauda Model RK 20) kept the sample temperature at 23° C.

The size determination by means of photon correlation spectroscopy gave the hydrodynamic radius

$${r}_{H} = \frac{kT}{6 πη {〈 D 〉}_{Z}} ,$$

where kT is the thermal energy, η is the dynamic viscosity and

$${〈 D 〉}_{Z} = \frac{\int D ( r ) {m}^{2} ( r ) ⅆ r}{\int {m}^{2} ( r ) ⅆ r} ( m ( r ) \text{:} mass of a particle of radius r )$$

is the Z-average of the diffusion coefficient

$$D ( r ) = \frac{kT}{6 πη r} .$$

The width of the distribution was stated as the “coefficient of variation” (CV); this is the standard deviation with respect to the intensity or Z averaging, normalized with the mean value:

$$CV = {[ \frac{{〈 {D}^{2} 〉}_{Z} - {〈 D 〉}_{Z}^{2}}{{〈 D 〉}_{Z}^{2}} ]}^{1 / 2} .$$

### (I) PREPARATION OF COMPOSITIONS ACCORDING TO THE INVENTION AND COMPARATIVE COMPOSITIONS

I.1. Preparation of Composition Z1 According to the Invention

The following were mixed with one another in a 1 liter stirred vessel having a heating apparatus:

| | |
|---|---|
| 7.50 g | of n-C₁₀H₂₁—O—(CH₂—CH₂—O)₃—H |
| 7.50 g | of n-C₁₀H₂₁—O—(CH₂—CH₂—O)₄—H |
| 250 g | of rapeseed oil methyl ester (B1) having a dynamic viscosity of |
| | 4.5 mPa · s, measured according to DIN EN ISO 3219 at 23° C. |

The mixture thus obtained was heated to 85° C. Thereafter, 250 g of distilled water, which had a temperature of 80° C., were added dropwise over a period of 15 minutes, and vigorous stirring (20 000 revolutions per minute) was effected during the addition. Vigorous stirring was continued for a further 30 minutes, followed by cooling in an ice bath to room temperature. Composition Z1 according to the invention was obtained.

I.2. Preparation of Composition Z2 According to the Invention

The following were mixed with one another in a 1 liter stirred vessel having a heating apparatus:

| | |
|---|---|
| 2.30 g | of n-C₁₈H₃₇—O—(CH₂—CH₂—O)₂₅—H |
| 2.08 g | of n-C₁₀H₂₁—O—(CH₂—CH₂—O)₇—H |
| 1.62 g | of n-C₁₂H₂₅—O—(CH₂—CH₂—O)₈₀—H |
| 240 g | of a hydrophobic component B2, which was prepared as follows: |

A mixture of capellan oil and rapeseed oil (weight ratio 40:60) was first oxidized with air until a density difference Δd of 0.1 was reached, and then reacted with 8% by weight, based on the sum of unoxidized mixture of capellan oil and rapeseed oil, of Na₂S₂O₅.

The mixture thus obtained was heated to 85° C. Thereafter, 360 g of distilled water, which had a temperature of 80° C., were added dropwise over a period of 5 hours, and stirring was effected during the addition. Stirring was continued for a further 30 minutes, followed by cooling in an ice bath to room temperature. Composition Z2 according to the invention was obtained.

I.3. Preparation of Comparative Composition V3

| | |
|---|---|
| 7 g | of n-C₁₈H₃₇—O—(CH₂—CH₂—O)₂₅—H |
| 240 g | of a hydrophobic component B3, which was prepared as follows: |

A mixture of capellan oil and rapeseed oil (weight ratio 40:60) was first oxidized with air until a density difference Δd of 0.1 was reached, and then 9 parts by weight (based on the sum of the masses of capellan oil and rapeseed oil) of a mixture of coconut oil monoethanolamine and maleic anhydride were added (weight ratio 70:30) and reaction with 12% by weight, based on the sum of starting materials, of Na₂S₂O₅ was then effected.

The mixture thus obtained was then diluted with 360 g of distilled water which had a temperature of 20° C. Comparative composition V3 was obtained.

### II. DETERMINATION OF TRANSMITTANCE AND MEAN HYDRODYNAMIC RADIUS

In each case the mean hydrodynamic radius and the transmittance of Z1, Z2 and V3 were determined.

The transmittance was measured in each case at 400 nm and at an aqueous dilution of 1:499 (parts by volume) at a sample layer thickness of 1 cm. The results are shown in table 1.

TABLE 1
Properties of Z1, Z2 and V3

| | Mean hydrodynamic | Transmittance | |
|---|---|---|---|
| Sample | radius [nm] | [%] | pH |
| Z1 | 20 | n.d. | 4.8 |
| Z2 | 61 | 90 | 5.1 |
| V3 | 220 | 75 | 5.6 |

n.d.: not determined

### III. USE EXAMPLES

III.1. Production of Automotive Leather

The data in % by weight are based in each case on the shaved weight, unless stated otherwise. In all operations, the drum was rotated about 10 times per minute, unless stated otherwise.

In a rotatable 50 l drum having internals, 100% by weight of water having a temperature of 35° C., 2% by weight of dispersant 3 from EP 0 463 401 A2 and 1.6% by weight of sodium formate and, after half an hour, 0.3% by weight of NaHCO₃ were added to 2.5 kg of chrome-tanned wet blue having a shaved thickness of from 1.1 to 1.3 mm. After 15 minutes, 0.6% by weight of NaHCO₃ was added and deacidification was effected at 35° C. over a period of 60 minutes so that a pH of 4.9 resulted.

The leather was then washed with water, and 80% by weight of water and 2% by weight of dispersant 3 from EP 0 463 401 A2 were added. Drumming was effected for 20 minutes; a pH of 5.8 resulted.

0.6% by weight of polymer having the following characteristic data was then added: 30% strength by weight aqueous polymer solution partly neutralized with NaOH; homopolymer of methacrylic acid, Mₙ about 10 000; Fikentscher K value: 12, viscosity of the 30% by weight solution: 65 mPa·s (DIN EN ISO 3219, 23° C.), pH 5.1. Retanning was effected for 30 minutes.

2% by weight of sulfone tanning agent from EP-B 0 459 168, example K1 and 5% by weight of the vegetable tanning agent mimosa extract, commercially available from BASF Aktiengesellschaft, were then added. The treatment was continued over a period of one hour.

1% by weight of a black dye mixture, which had the following composition, was then added:

70 parts by weight of black dye according to WO 98/41581, example 2.2 and

30 parts by weight of Acid Black 194 (chromium complex), Colour Index 194.

80% by weight of water were added, heating to 55° C. was effected and the composition according to the invention according to table 2 or comparative composition was added. After 60 minutes, a pH of 3.7 was established with formic acid.

Finally, the liquor was discharged and the COD value determined. The leather was washed twice with water, dried, and worked up in a manner customary in tanning. The leathers 3.1 to 3.2 according to the invention and the comparative leather V3.3 according to table 2 were obtained.

The performance characteristics of the leathers obtained are shown in table 2.

TABLE 2
Performance characteristics of leathers 3.1 to 3.2 (according
to the invention) and comparative leather V3.3

| | Composition | | | COD value of |
|---|---|---|---|---|
| Leather | used | Fullness | Softness | wastewater [mg O₂/I] |
| 3.1 | Z1 | very good | good | 6690 |
| 3.2 | Z2 | very good | very good | 8900 |
| V3.3 | V3 | good | good | 24 000 |

1-14. (canceled)

15. A composition comprising, as components,
(a) at least two alkoxylated alcohols,
(b) at least one hydrophobic component selected from the group consisting of natural, modified natural and synthetic hydrophobic substances, and
(c) at least 20% by weight of water, based on the total weight of the composition,
wherein the composition has a mean hydrodynamic droplet radius in the range from 1 to 200 nm, determined by dynamic light scattering.

16. The composition according to claim 15, which comprises, as component (a), a mixture of at least three alkoxylated alcohols.

17. The composition according to claim 15, which, in an aqueous dilution of 1:499 (parts by volume), has a transmittance of at least 80% at a wavelength of 400 nm and a sample layer thickness of 1 cm.

18. The composition according to claim 15, wherein at least one hydrophobic component is selected from the group consisting of natural fats and natural oils, highly oxidized low-sulfited natural fats or oils, mineral oils, white oils, silicone oils, synthetic waxes and hydrophobic (co)polymers.

19. The composition according to claim 15, which comprises
(c) at least 40% by weight of water, based on the total weight of the composition.

20. The composition according to claim 15, which further comprises
(a) at least one ionic or nonionic emulsifier.

21. The composition according to claim 15, which further comprises
(a) at least one additive.

22. The composition according to claim 15, which is substantially free of low molecular weight alcohols and low molecular weight glycols.

23. A process for the preparation of a composition according to claim 15, wherein
(a) at least two alkoxylated alcohols,
(b) at least one hydrophobic component selected from the group consisting of natural, modified natural and synthetic hydrophobic substances,
(d) optionally, at least one ionic or nonionic emulsifier and
(e) optionally, at least one additive
are mixed with one another and then
(c) at least 20% by weight of water, based on the total weight of the composition, are added, said water having a temperature of at least 70° C. during the addition.

24. The process according to claim 23, wherein said water has a temperature in the range of from 80° C. to 100° C. during the addition.

25. A process for the preparation of a composition according to claim 15, wherein
(a) at least two alkoxylated alcohols,
(b) at least one hydrophobic component selected from the group consisting of natural, modified natural and synthetic hydrophobic substances,
(c) at least 20% by weight of water, based on the total weight of the composition,
(d) optionally, at least one ionic or nonionic emulsifier and
(e) optionally, at least one additive
are mixed with one another and then the resulting mixture is heated to a temperature of at least 70° C.

26. The process according to claim 23, wherein a mixture of at least 3 alkoxylated alcohols is used as component (a).

27. The process according to claim 25, wherein a mixture of at least 3 alkoxylated alcohols is used as component (a).

28. A method of using a composition according to claim 15 for the production of leather or fur skins.

29. A process for the production of leather or fur skins using compositions prepared by a process according to claim 23.

30. A process for the production of leather or fur skins using compositions prepared by a process according to claim 25.
